(19) United States
(12) Patent Application Publication
(10) Pub. No.: US 2013/0171935 A1
(43) Pub. Date: Jul. 4, 2013

(54) METHOD FOR ESTABLISHING CONNECTION BETWEEN WIRELESS COMMUNICATION DEVICES

(71) Applicants: Kuei-Pin Tsai, Miaoli County (TW); Jheng-You Lin, Taichung City (TW); Guo-Zua Wu, Taichung City (TW); Tsung-Jen Hsieh, Taichung City (TW)

(72) Inventors: Kuei-Pin Tsai, Miaoli County (TW); Jheng-You Lin, Taichung City (TW); Guo-Zua Wu, Taichung City (TW); Tsung-Jen Hsieh, Taichung City (TW)

(73) Assignee: INDUSTRIAL TECHNOLOGY RESEARCH INSTITUTE, Hsinchu (TW)

(21) Appl. No.: 13/413,667

(22) Filed: Mar. 7, 2012

(30) Foreign Application Priority Data
Dec. 28, 2011 (TW) 100149290

(51) Int. Cl. H04B 7/00; H04W 12/04; H04W 12/00

(52) U.S. Cl. 455/41.2

(57) ABSTRACT

A method for establishing a connection between wireless communication devices suitable for sharing data between a sender and a receiver is provided. Both the sender and the receiver respectively have a built-in acceleration sensor to enable the sender and the receiver obtaining an internal tap-data and external tap-data. A first-connection is established between the sender and at least one receiver all around. The sender bumps the receiver both for sharing data. The sender receives the external tap-data from at least one receiver via the first-connection, the internal tap-data is compared with the external tap-data to filter out not-bumped receivers and then the bumped receiver is confirmed. Then, a second-connection is established between the bumped sender and receiver according to a security protocol so as to mutually share data through the second connection between the sender and the receiver.

### CROSS-REFERENCE TO RELATED APPLICATION

This application claims the priority benefit of Taiwan application serial no. 100149290, filed on Dec. 28, 2011. The entirety of the above-mentioned patent application is hereby incorporated by reference herein and made a part of this specification.

### BACKGROUND

1. Technical Field

The disclosure generally relates to a connection mechanism. And more particularly, to a method for establishing a connection between wireless communication devices in bumping way.

2. Background

Along with the progress of science and technology, the portable electronic device gets fast and massive growth, which, such as a cellular phone and a personal digital assistant (PDA) cellular phone, provides the modern people with anytime, anywhere communications or contacts. Meanwhile, portable electronic devices have becomes indispensable important articles for use of the modern people.

Due to the fast growth of the portable electronic device, many of them with wireless communication function employ a powerful central processing unit (CPU) and useful sensors. As a conventional way before, when a user wants to use wireless communication to share data, for example, to share the data by Bluetooth in a cellular phone, the user must select the data to be transmitted first, then select a target device to be transmitted to, then input a pin code that defined by the target device and finally click a button to send out a data to be shared.

It is obvious the above-mentioned conventional way is too complicate. In addition, during delivering the data, the pin code is likely to be stolen so as to be attacked by malicious remote devices. In this regard, the security needs to be strengthened.

### SUMMARY

The disclosure is directed to a method for establishing a connection between wireless communication devices, which is suitable for sharing data between a sender and a receiver. Both the sender and the receiver herein have a built-in acceleration sensor. In the method, a first-connection is established between the sender and at least one receiver all around. When bumping the sender and the receiver, the sender receives an external tap-data from at least one receiver via the first-connection. The sender obtains an internal tap-data through a built-in acceleration sensor thereof, while the receiver obtains the external tap-data through the built-in acceleration sensor thereof. And by comparing the internal tap-data with the external tap-data, the receivers with no bumping are filtered out so as to confirm one bumped receiver among all the receivers. After that, a second-connection is established between the sender and the bumped receiver according to a security protocol so that the sender and the receiver can mutually share data via the second-connection.

Several exemplary embodiments accompanied with figures are described in detail below to further describe the disclosure.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic block diagram illustrating a wireless communication device according to the first exemplary embodiment of the disclosure.

FIG. 2 is a bumping diagram according to the first exemplary embodiment of the disclosure.

FIG. 3 is a flowchart illustrating a connection method according to the first exemplary embodiment of the disclosure.

FIG. 4 is a schematic plot of an acceleration data curve according to the first exemplary embodiment of the disclosure.

FIG. 5 is a schematic diagram illustrating the data structure of a tap-data according to the first exemplary embodiment of the disclosure.

FIGS. 6A and 6B are two schematic plots of two tap-data according to the first exemplary embodiment of the disclosure.

FIG. 7 is a schematic diagram illustrating a communication system according to the second exemplary embodiment of the disclosure.

FIG. 8 is a schematic diagram illustrating a method for establishing a connection according to the second exemplary embodiment of the disclosure.

### DETAILED DESCRIPTION OF DISCLOSED EMBODIMENTS

When a user wants to use the wireless communication device thereof (sender) to share data with other wireless communication devices all around (receivers), the user's device likely experiences a risk of attack by a malicious device. In this regard, the disclosure provides a method for establishing a connection between wireless communication devices, which can establish a secure connection between the sender and the receiver through a bumping mechanism and reduce the risk of stealing data during transmission. In order to better understand the disclosure content, exemplary embodiments are explained in following.

### The First Embodiment

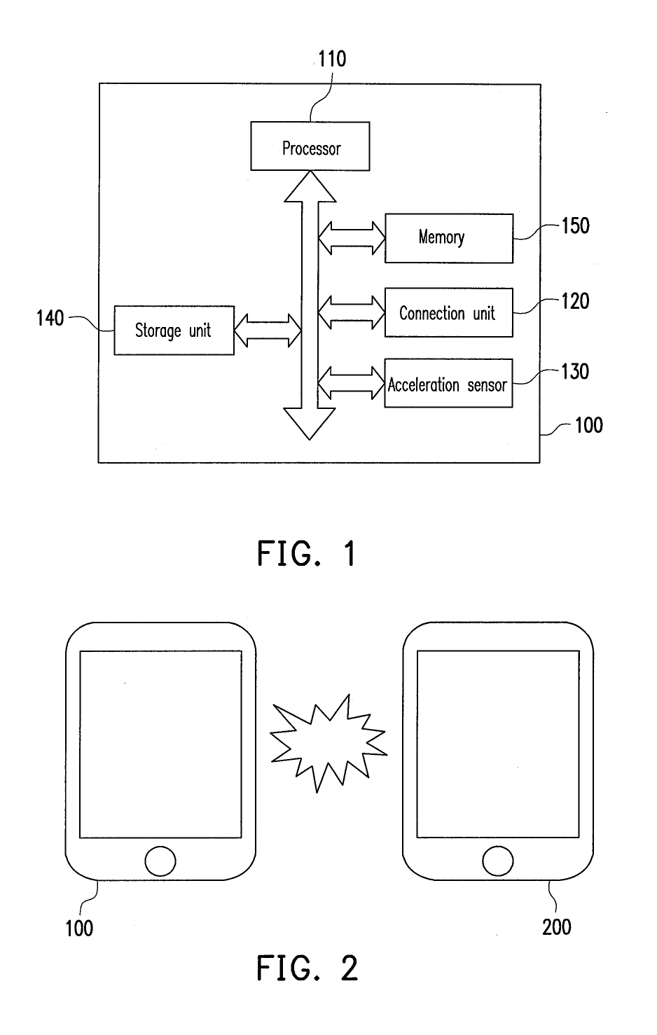

FIG. 1 is a schematic block diagram illustrating a wireless communication device according to the first exemplary embodiment of the disclosure. Referring to FIG. 1, a wireless communication device 100 includes a processor 110, a connection unit 120, an acceleration sensor 130, a storage unit 140 and a memory 150. The processor 110 is coupled respectively to the connection unit 120, the acceleration sensor 130, the storage unit 140 and the memory 150.

The above-mentioned processor 110 is, for example, a central processing unit (CPU) for interpreting the computer instructions so as to execute the hardware operation and the firmware operation in the wireless communication device 100 and processing the data in the software. The connection unit 120 has, for example, a Bluetooth function for establishing connections with other external communication devices all around. The memory 150 is, for example, a random access memory (RAM) for loading various programs and data to provide the processor 110 for directly executing and using. The storage unit 140 is, for example, a hard drive to store various data.

The acceleration sensor 130 is for detecting whether or not the wireless communication device 100 shakes to provide a corresponding acceleration data so that the processor 110 is able to judge the occurrence of tap-data according to the acceleration data. That is because the tap-data may be produced by rocking, fast moving or tapping the acceleration sensor or by bumping another acceleration sensor. In other words, the processor 110 would execute a tap-data judgement mechanism to judge whether or not the acceleration data received by the acceleration sensor 130 is the tap-data produced during mutual bumping between the wireless communication device 100 and other external communication devices.

FIG. 2 is a bumping diagram according to the first exemplary embodiment of the disclosure. Referring to FIG. 2, when a user wants to use the wireless communication device 100 (sender) to share data with another external communication device 200 (receiver), the user can bump the sender 100 against the receiver 200. At the time, the sender 100 produces an internal tap-data itself and receives an external tap-data from the receiver 200. After that, the sender 100 is able to judge whether or not a bumping occurs between the receiver 200 and itself through a bumping verification mechanism so as to establish a secure connection after judging out the bumping occurs between the sender 100 and the receiver 200. In this way, it allows to share data between the sender 100 and the receiver 200 via the secure connection.

In addition, the external communication device 200 (receiver) also has a processor, an acceleration sensor and a connection unit, the internal parts thereof are, for example, the same as or similar to the wireless communication device 100, which is omitted to describe.

The steps of establishing a connection between the above-mentioned wireless communication device 100 (sender) and the external communication device 200 (receiver) are explained in following.

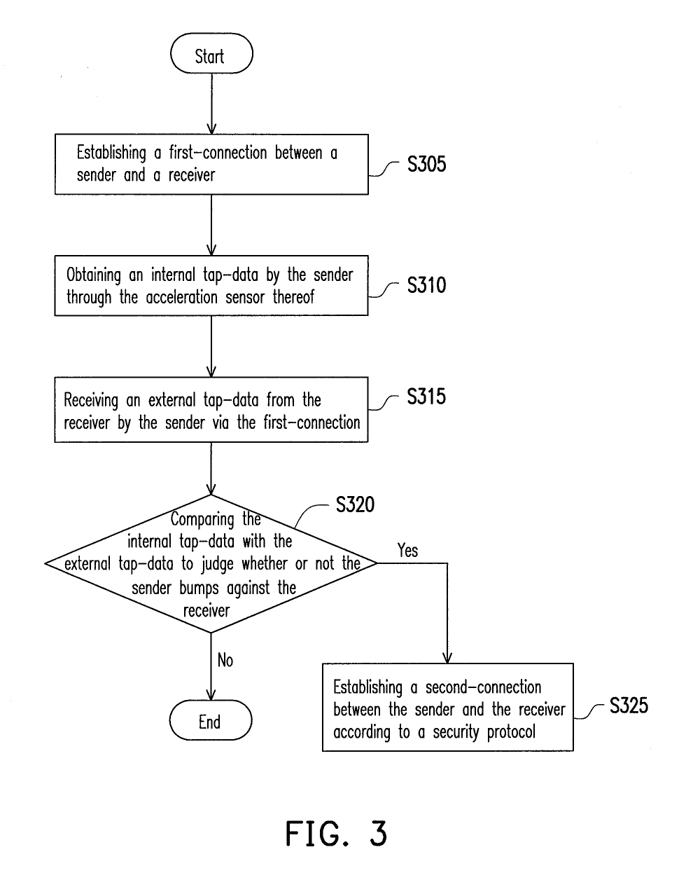

FIG. 3 is a flowchart illustrating a connection method according to the first exemplary embodiment of the disclosure. Referring to FIGS. 1-3, in step S305, a first-connection is established between the sender 100 and the external communication device 200 (receiver) all around through the connection unit 120. The first-connection herein is a regular connection without encryption and is, for example, a connection by using the short distance wireless technology such as a Bluetooth connection or an infrared ray (IR) connection or a near field communication (NFC) connection.

For example, the sender 100 would scan a connection range all around by the connection unit 120 so as to search for whether or not there are other external communication devices within the connection range. In FIG. 2, for example, assuming the sender 100 and the receiver 200 respectively have Bluetooth function, when the sender 100 has searched out an external communication device 200 within the connection range all around, the sender 100 transmits an inquiry packet to the receiver 200. After the external communication device 200 within the connection range receives the inquiry packet, it would return back a response packet to the sender 100, in which the response packet includes a connection identifier. When the sender 100 receives the response packet from the receiver 200, the connection identifier carried in the response packet is checked to judge whether or not the connection identifier conforms to a predetermined value. If the connection identifier in the response packet conforms to the predetermined value, the first-connection (for example, a Bluetooth connection) between the sender 100 and the receiver 200 is established; if the connection identifier in the response packet does not conform to the predetermined value, the external communication device is treated as a non-receiver, and no first-connection is established between the sender 100 and the external communication device. The connection identifier herein is, for example, a universally unique identifier (UUID).

In the practice, a bump application is installed respectively in the sender 100 and the receiver 200, in which the two bump applications have the same UUID. In this way, only the devices installing the bump application are able to establish the first-connection.

In step S310, the sender 100 obtains an internal tap-data through the acceleration sensor 130. In more details, the acceleration sensor 130 would produce an acceleration value along with moving, bumping or shaking of the sender 100, and the processor 110 can judge whether or not the sender 100 bumps the receiver 200 according to the acceleration values.

In order for the processor 110 to judge whether or not the acceleration value produced by the acceleration sensor 130 is an internal tap-data, a bumping time and a first threshold are defined so as to obtain the internal tap-data produced by the bumping among multiple acceleration values and filter out the acceleration value produced by a non-bumping situation. The first threshold is configured for filtering out the acceleration value produced by operating the wireless communication device with the user, while the bumping time is configured for filtering out the acceleration value produced by long-time shaking the wireless communication device with the user. In general speaking, the time of a bumping between two devices is quite short. Thus, when the processor 110 continuously detects out multiple acceleration values greater than the first threshold within a duration, it must be judged whether or not the above-mentioned duration is less than the defined bumping time. If the duration is less than the defined bumping time, it is decided the acceleration values are internal tap-data produced by bumping.

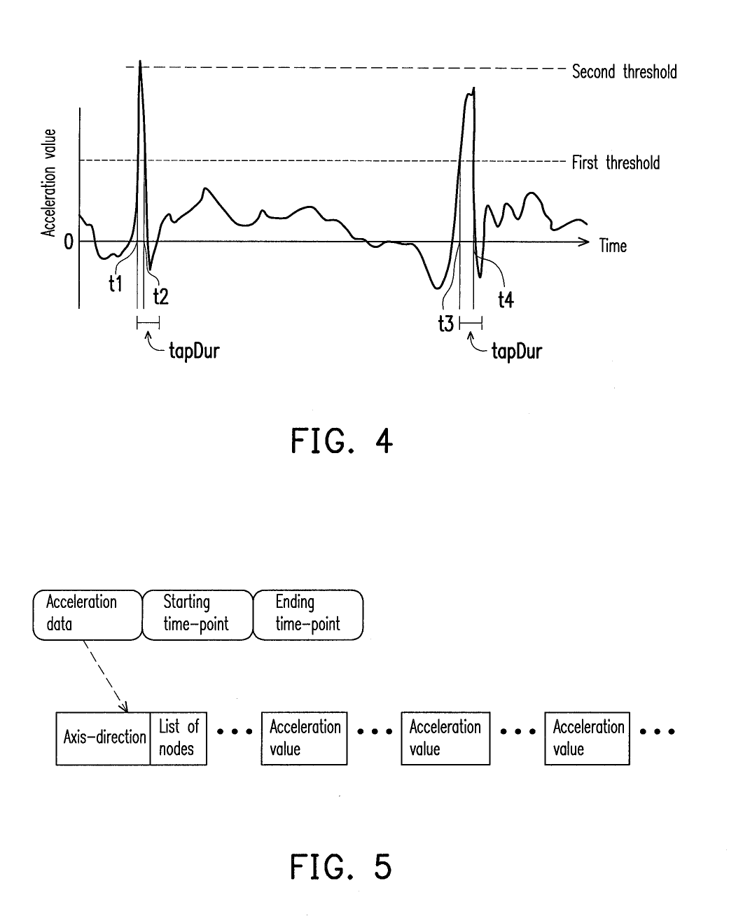

FIG. 4 is a schematic plot of an acceleration data curve according to the first exemplary embodiment of the disclosure, which can serve as an example. The plot of an acceleration data curve of the embodiment is made according to the acceleration data obtained by the acceleration sensor 130 of the wireless communication device 100 (sender), in which abscissa represents sampling time-point and the ordinate represents acceleration value. In terms of a 3-axises acceleration sensor, since the X-axis, the Y-axis and the Z axis have both +/− directions, the absolute value is used to represent the intensity of the acceleration and compared with the first threshold.

Referring to FIG. 4, during a time between two sampling time-points t1 and t2, when the acceleration values detected in the duration (t2−t1) are all greater than the first threshold, it is required to judge whether or not the duration is less than the bumping time tapDur. For example, assuming the bumping time tapDur is 0.5 sec, if the duration is less than 0.5 sec, it can be judged out a bumping may occur in the duration (t2−t1); if the duration is greater than 0.5 sec, it indicates no bumping occurs with the wireless communication device, instead, that may be a situation for the user to shake the device or the device is in rock state due to other situations. At the time, the acceleration values are treated as non internal tap-data to be excluded.

On the other hand, in order to increase the identifying accuracy of the internal tap-data and avoid misjudging the detected acceleration values triggered by common shaking as internal tap-data, it is further judged whether or not a maximal value in the acceleration values is greater than a second threshold. If the maximal value is greater than the second threshold and the duration is less than the bumping time, the acceleration values are decided as the internal tap-data.

For the acceleration values between the sampling time-point t3 and the sampling time-point t4, as an example, if the acceleration values detected in the duration (t4-t3) are all greater than the first threshold and the duration (t4-t3) is less than the bumping time tapDur, but the maximal acceleration value in the duration (t4-t3) is not greater than the second threshold, the acceleration values detected in the duration (t4-t3) are treated as non internal tap-data to be excluded. In the other hand, during the time between two sampling time-points t1 and t2, since the acceleration values detected in the duration (t2−t1) are all greater than the first threshold and the duration (t2−t1) is less than the bumping time tapDur and the maximal acceleration value in the duration (t2−t1) is greater than the second threshold, the acceleration values detected in the duration (t2−t1) are treated as internal tap-data.

Back to FIG. 3, in step S315, the sender 100 receives an external tap-data via the first-connection from the receiver 200. During the bumping, both the sender 100 and the receiver 200 synchronically judge the internal/external tap-data, in which the methods for the external communication device 200 (receiver) and the wireless communication device 100 (sender) to judge whether or not the acceleration data detected by the acceleration sensors thereof are the external tap-data should be the same, which is omitted to describe.

Then in step S320, the internal tap-data is compared with the external tap-data and the both timestamps are compared with each other to judge whether or not a bumping occurs between the sender 100 and the receiver 200. For this purpose, for example, the both starting time-points (i.e., timestamps) of the internal tap-data and the external tap-data are compared to decide whether or not the difference of starting time-points is within a limiting time (for example, 0.05 ms). If the difference of both starting time-points is not within the limiting time, the external communication device is treated as a non-receiver to be excluded. Although the both starting time-points of the internal tap-data and the external tap-data should be in theory the same, but due to the influence by external environment, an error may be presented, so that a limiting time is specified to tolerate the error. In addition, both system times of the sender 100 and the receiver 200 are not exactly the same, so that the system time difference between the sender 100 and the receiver 200 is recorded during establishing the first-connection and the time difference is used for the successive comparison between the both starting time-points. The comparison can be done according to, for example, the following formula:

T_{S}−(T_{R}+T_{differ})<Tₗᵢₘᵢₜ;

wherein T_{S} is the starting time-point of the sender (wireless communication device 100), T_{R} is the starting time-point of the receiver (external communication device 200), T_{differ} is the system time difference between the sender and the receiver and Tₗᵢₘᵢₜ is the limiting time. Assuming, for example, the system time of the sender 100 is 10′:18″ and the system time of the receiver 200 is 10′:19″ during establishing the first-connection, the system time difference of them is 1 sec.

If the difference of both starting time-points of the internal tap-data and the external tap-data is within the limiting time, the sender 100 further compares the internal tap-data with the external tap-data to judge whether or not the two data conforms to a proportion range. If the internal tap-data and the external tap-data conform to the above-mentioned proportion range, it is judged out the sender 100 bumps the receiver 200; if the internal tap-data and the external tap-data do not conform to the above-mentioned proportion range, the external communication device is treated not as the receiver 200 bumping the sender 100 and the external communication device is excluded. The internal tap-data and the external tap-data respectively include multiple acceleration values, by which whether or not a bumping between the sender 100 and the receiver 200 occurs can be judged.

Another embodiment in following is described to explain the data structure of the above-mentioned tap-data. FIG. 5 is a schematic diagram illustrating the data structure of a tap-data according to the first exemplary embodiment of the disclosure. Referring to FIG. 5, the two data structures of the above-mentioned internal tap-data and the external tap-data respectively include multiple fields. In the fields, acceleration data for judging bumping presence, starting time-point and ending time-point for judging bumping presence in duration are respectively recorded. The acceleration data includes axis-directions of acceleration values and a list of nodes, in which each sampling time-point is treated as a node and the list of nodes includes the acceleration value of every sampling time-point.

During establishing the first-connection, the system time difference between sender 100 and the receiver 200 is recorded. Then, when the sender 100 produces an internal tap-data and receives an external tap-data, the above-mentioned system time difference is used to judge whether or not the both timestamps (i.e., the two starting time-points) of bumping occurrence respectively recorded on the internal tap-data and the external tap-data are within the limiting time (for example, 0.05 ms). That is to say it is judged according to the above-mentioned formula: T_{S} of the sender's starting time-point−(T_{R} of the receiver's starting time-point+T_{differ} of system time difference)<Tₗᵢₘᵢₜ of limiting time. When the internal tap-data and the external tap-data are subject to the above-mentioned formula, a bumping mechanism verification is further performed, i.e., comparing the internal tap-data with the external tap-data is performed to judge whether or not the two data conforms to a proportion range.

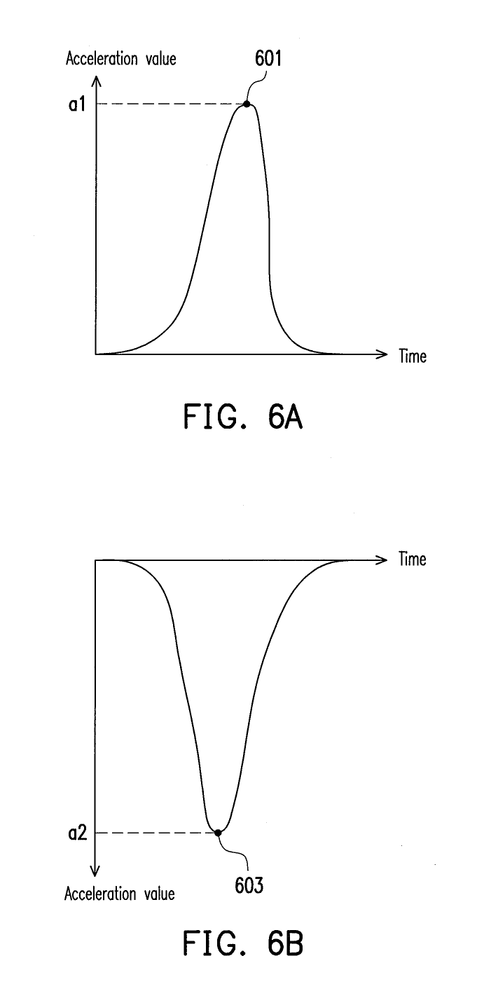

FIGS. 6A and 6B are, for example, two schematic plots of two tap-data according to the first exemplary embodiment of the disclosure, in which FIG. 6A is the curve plot of the internal tap-data detected by the acceleration sensor 130 of the sender 100 and FIG. 6B is the curve plot of the external tap-data detected by the acceleration sensor of the receiver 200. Assuming both the sender 100 and the receiver 200 are smart phones, the touch surfaces of them during touch operations are towards above, the operation directions are defined as positive directions (shown by FIG. 2) and they are bumped against each other, so that one of the acceleration values produced by the sender 100 and the receiver 200 takes the positive direction, while the other takes the negative direction. It is also assumed the acceleration values of the sender 100 and the receiver 200 are respectively in the positive direction and the negative direction.

The two acceleration values of each sampling time-point respectively corresponding to the internal tap-data and the external tap-data are compared to see whether or not the values conform to the proportion range. Taking a pair of node 601 and node 603 as an example, the acceleration value of the node 601 is a1, the acceleration value of the node 603 is a2, the absolute value |a1/a2| of the proportional/a2 is compared with the proportion range (for example, 0.2-0.8), and analogically for the other sampling time-points. By comparing the acceleration proportion of each sampling time-point one by one to see whether or not the acceleration proportions of all sampling time-points conform to the proportion range. Only all the acceleration proportions conform to the proportion range, it is decided the internal tap-data and the external tap-data are produced by a same bumping.

Referring to FIG. 3 again, if the timestamps of the internal tap-data and the external tap-data are not within the limiting time, or the acceleration values at each sampling time-point of them do not conform to the proportion range, the external communication device is judged out that the receiver 200 is not one bumping the receiver 100, and accordingly the successive operations to establish connection with the external communication device is stopped. If it is judged the sender 100 bumps the receiver 200, step S325 is performed, where the second connection is established between the sender 100 and the receiver 200 according to a security protocol. The second-connection can be an encrypted Bluetooth connection. In other embodiments, the second-connection can be also a wireless fidelity certification connection (Wi-Fi certification connection) or a worldwide interoperability for microwave access connection (WiMAX connection).

At the time the sender 100 and the receiver 200 are able to share data therebetween via the second-connection. For example, the both parties execute a key exchange mechanism through the security protocol, so as to establish a session key for sharing secrets, followed by using the session key for the both parties to transmit secure and encrypted data. The above-mentioned session key can be produced by the internal tap-data and the external tap-data after computations, which the disclosure is not limited to.

### The Second Embodiment

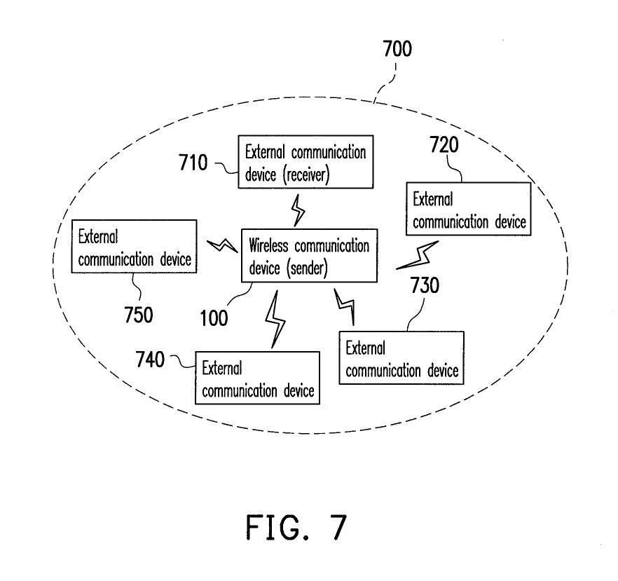

FIG. 7 is a schematic diagram illustrating a communication system according to the second exemplary embodiment of the disclosure. Referring to FIGS. 1 and 7, in the embodiment, in a connection range 700 all around of the wireless communication device 100 (sender), there are five external communication devices 710, 720, 730, 740, 750. Assuming all the wireless communication device 100 and the external communication devices 710, 720, 730 and 740 installed the same bump application, but another external communication device 750 has no the bump application installed. And the wireless communication device 100 (sender) executes the bump application to transmit data between the sender 100 and other external communication devices through bumping way.

After the wireless communication device 100 (sender) starts the bump application, the connection unit 120 thereof scans the connection range 700 all around so as to search for whether or not there are other external communication devices within the connection range having the same connection function as the wireless communication device 100 (sender). It is assumed all the wireless communication device 100 and the external communication devices 710, 720, 730, 740 and 750 have a short distance wireless technology (such as a Bluetooth function).

When the external communication devices 710, 720, 730, 740 and 750 within the connection range 700 receive the inquiry from the wireless communication device 100 (sender), they would respectively return back a response packet to the wireless communication device 100 (sender). Since the external communication devices 710, 720, 730 and 740 have a same installed bump application as the wireless communication device 100 (sender), the connection identifiers carried in the response packets sent by the external communication devices 710, 720, 730 and 740 are the same as the predetermined value in the wireless communication device 100 (sender). However, the external communication device 750 does not install the bump application, so that the connection identifier carried in the response packet sent by the external communication device 750 is different from the predetermined value in the wireless communication device 100. Thus, the wireless communication device 100 excludes the external communication device 750 and no first-connection would be established between the two devices 100 and 750.

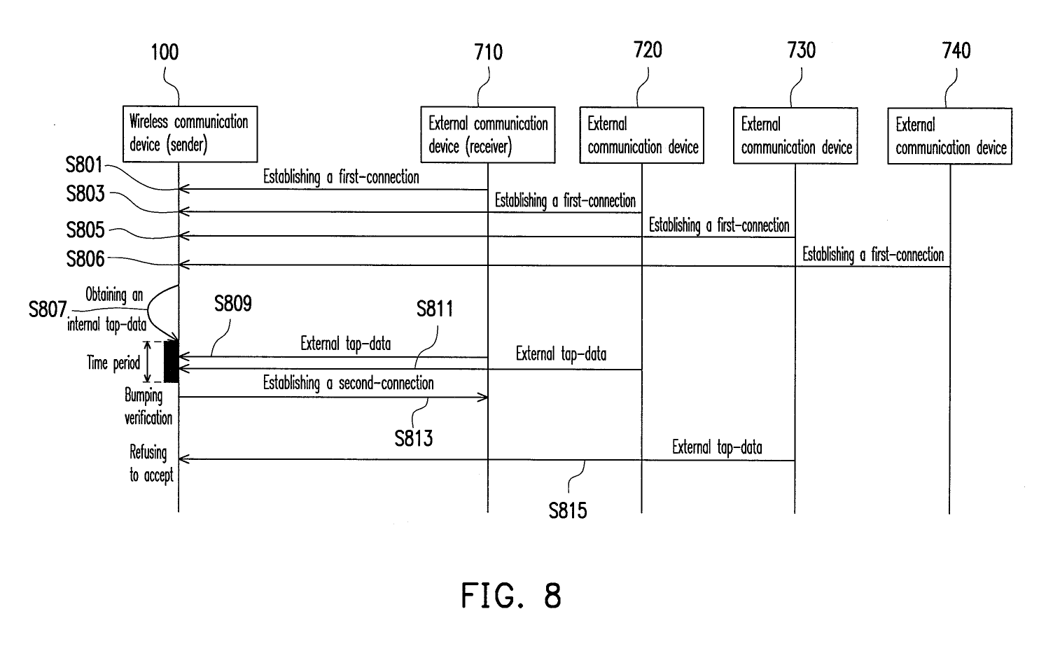

The method for establishing a connection between wireless communication devices is described in following by taking the wireless communication device 100 (sender) and the external communication devices 710, 720, 730 and 740 as an example. FIG. 8 is a schematic diagram illustrating a method for establishing a connection according to the second exemplary embodiment of the disclosure. Referring to FIGS. 1, 7 and 8, assuming all the wireless communication device 100 (sender) and the external communication devices 710, 720, 730 and 740 installed the same bump application, after the wireless communication device 100 (sender) starts the bump application to scan the connection range 700, a first-connection is respectively established between the sender 100 and the external communication devices 710, 720, 730 and 740, which are shown by steps S801, S803, S805 and S806.

In the wireless communication device 100 (sender), the processor 110 executes the bump application to obtain the internal tap-data through the acceleration sensor 130, as shown by step S807. The way of obtaining the internal tap-data is similar to step S310 in the above-mentioned first embodiment, which is omitted to describe.

After the wireless communication device 100 (sender) obtains the internal tap-data, a time period is set and only in the time period the first-connection is open to accept data so as to avoid long time attack by other malicious devices. That is to say, after the first-connections are established between the wireless communication device 100 (sender) and the external communication devices 710, 720, 730 and 740, only in the time period after producing the internal tap-data in the wireless communication device 100 (sender), the first-connection is open to accept tap-data, while after the time period, the first-connection does not accept tap-data.

At the time the external communication devices 710 and 720 in the time period detect out an external tap-data produced by bumping, but the external communication device 740 does not detect out the produced external tap-data. Thus, the wireless communication device 100 (sender) would receive the external tap-data from the external communication devices 710 and 720, as shown by steps S809 and S811. Since the external communication device 740 does not produce the external tap-data, no data is transmitted from there to the wireless communication device 100 (sender). In addition, the external communication device 730 sends out the external tap-data after the time period to the wireless communication device 100 (sender), as shown by step S815, so that the wireless communication device 100 (sender) refuses to accept the external tap-data because the transmission data of the external communication device 730 occurs after the time period.

In steps S809 and S811, within the time period after the wireless communication device 100 (sender) obtains the internal tap-data, the processor 110 respectively receives the external tap-data from the external communication devices 710 and 720 via the first-connection.

After receiving the external tap-data, the wireless communication device 100 (sender) executes a bumping verification, where the internal tap-data is compared with every received external tap-data so as to judge whether or not the wireless communication device 100 (sender) bumps the external communication device 710 or 720. The non-bumping external communication devices are filtered out according to the verification, and then the wireless communication devices (receivers) getting bumping by the wireless communication device 100 (sender) are further confirmed.

The wireless communication device 100 (sender) would compare the internal tap-data thereof with the external tap-data received from the external communication device 710 and with the external tap-data received from the external communication device 720. The bumping verification herein is the same as or similar to the step S320 in the above-mentioned first embodiment, which is omitted to describe.

Assuming the internal tap-data of the wireless communication device 100 and the external tap-data received from the external communication device 710 conform to a proportion range, it is judged out the wireless communication device 100 bumps the external communication device 710. At the time, the external communication device 710 is the receiver 200 and step S813 is performed, in which the second-connection is established between the wireless communication device 100 (sender) and the external communication device 710 (receiver) according to a security protocol.

Further, assuming multiple external tap-data are continuously received from the external communication device 720, first, it is judged that whether or not the quantity of the external tap-data is beyond a predetermined value. Among multiple received external tap-data in a short time, if the quantity of the external tap-data sent from a same external communication device (assuming it is the external communication device 720) is beyond the predetermined value (for example, 5), it indicates the external communication device 720 uses massive external tap-data trying to pass the bumping verification. Thus, the wireless communication device 100 (sender) puts the external communication device 720 into the blacklist. For example, the media access control (MAC) address of the external communication device 720 is recorded in the blacklist, so that during scanning the connection range 700 in future, the external communication device 720 would be deleted off according to the blacklist and there is no chance to establish the first-connection with the external communication device 720.

In summary, in the above-mentioned embodiments, the sender can use a bumping mechanism to establish secure connections with the external communication devices (receivers) so as to protect the confidentiality of transmitting data of both parties. In addition, by defining a time period for accepting data, the disclosure can avoid malicious devices from trying to pass the bumping verification through using massive external tap-data, which reduces the risk of stealing data during data transmission and prevents the attack by malicious devices.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for establishing a connection between wireless communication devices, suitable for sharing data between a sender and a receiver, wherein both the sender and the receiver have a built-in acceleration sensor and the connection method comprises:
establishing a first-connection between the sender and at least one receiver;
bumping the sender against the receiver;
receiving an external tap-data from the at least one receiver by the sender via the first-connection, wherein the sender obtains an internal tap-data through the built-in acceleration sensor thereof and the receiver obtains the external tap-data through the built-in acceleration sensor thereof;
comparing the internal tap-data with the external tap-data to filter out non-receivers but confirm the receiver; and
establishing a second-connection between the sender and the receiver according to a security protocol so as to mutually share data between the sender and the receiver via the second-connection.

2. The method for establishing a connection between wireless communication devices as claimed in claim 1, wherein the step of establishing the first-connection comprises:
scanning a connection range by the sender so as to search for the at least one receiver;
when receiving a response packet from the at least one receiver, checking a connection identifier in the response packet for judging whether or not the connection identifier conforms to a predetermined value; and
if the connection identifier conforms to the predetermined value, establishing the first-connection between the sender and the receiver.

3. The method for establishing a connection between wireless communication devices as claimed in claim 2, wherein the connection identifier is a universally unique identifier (UUID).

4. The method for establishing a connection between wireless communication devices as claimed in claim 1, wherein the step of bumping the sender against the receiver further comprises: synchronically judging the internal/external tap-data by both the sender and the receiver which comprises:
when a plurality of acceleration values continuously detected by the acceleration sensor within a duration are all greater than a first threshold, judging whether or not the duration is less than a bumping time; and
if the duration is less than the bumping time, judging the acceleration values are the internal/external tap-data.

5. The method for establishing a connection between wireless communication devices as claimed in claim 4, wherein when the acceleration values continuously detected by the acceleration sensor within the duration are all greater than the first threshold, the method further comprises:
judging whether or not a maximal value among the acceleration values is greater than a second threshold; and
if the maximal value is greater than the second threshold and the duration is less than the bumping time, judging the acceleration values are the internal/external tap-data.

6. The method for establishing a connection between wireless communication devices as claimed in claim 4, wherein data structure of the internal/external tap-data comprises a plurality of fields, the fields are respectively for recording the acceleration values, an axis direction of the acceleration values, a starting time-point and an ending time-point of the duration.

7. The method for establishing a connection between wireless communication devices as claimed in claim 1, wherein the step of comparing the internal tap-data with the external tap-data further comprises:
comparing the two starting time-points of the internal tap-data and the external tap-data with each other so as to judge whether or not a difference between the two starting time-points of the internal tap-data and the external tap-data is within a limiting time and if the difference between the two starting time-points is beyond the limiting time, judging the receiver is a non-receiver to be excluded;
comparing the internal tap-data with the external tap-data to judge whether or not the two data conforms to a proportion range and if the two data do not conform to the proportion range, judging the receiver is a non-receiver to be excluded; and
if the two data conform to the proportion range, confirming a bumping occurs between the receiver and the sender.

8. The method for establishing a connection between wireless communication devices as claimed in claim 7, wherein the step of comparing the two starting time-points of the internal tap-data and the internal tap-data with each other so as to judge whether or not the difference between the two starting time-points of the internal tap-data and the external tap-data is within the limiting time is performed according to following formula:
T_{S}−(T_{R}+T_{differ})<Tₗᵢₘᵢₜ;
wherein T_{S} is the starting time-point of the sender, T_{R} is the starting time-point of the receiver, T_{differ} is a system time difference between the sender and the receiver and Tₗᵢₘᵢₜ is the limiting time.

9. The method for establishing a connection between wireless communication devices as claimed in claim 1, wherein the step of receiving the external tap-data by the sender is to receive the external tap-data of the at least one receiver via the first-connection within a time period after obtaining the internal tap-data.

10. The method for establishing a connection between wireless communication devices as claimed in claim 1, wherein in the step of establishing the second-connection between the sender and the bumped receiver according to the security protocol, the security protocol makes the both parties to execute a key exchange mechanism, so as to establish a session key for sharing secrets.

11. The method for establishing a connection between wireless communication devices as claimed in claim 10, wherein the session key is produced by the internal tap-data and the external tap-data after a computation.

12. The method for establishing a connection between wireless communication devices as claimed in claim 1, wherein after the step of receiving the external tap-data from the at least one receiver by the sender via the first-connection, the method further comprises:
judging whether or not quantity of the external tap-data is greater than a predetermined value; and
if the quantity of the external tap-data is greater than the predetermined value, recording the receiver who sending the external tap-data into a blacklist so as to exclude the receiver and not to establish the first-connection therewith.
